(19) United States
(12) Patent Application Publication
(10) Pub. No.: US 2018/0026305 A1
(43) Pub. Date: Jan. 25, 2018

(54) NONAQUEOUS ELECTROLYTE SECONDARY BATTERY

(71) Applicant: SANYO ELECTRIC CO., LTD., Daito-shi, Osaka (JP)

(72) Inventors: Akihiko Takada, Hyogo (JP); Takatoshi Higuchi, Hyogo (JP); Daisuke Nishide, Hyogo (JP); Atsushi Fukui, Hyogo (JP)

(73) Assignee: SANYO ELECTRIC CO., LTD., Daito-shi, Osaka (JP)

(21) Appl. No.: 15/550,569

(22) PCT Filed: Feb. 18, 2016
(86) PCT No.: PCT/JP2016/000863

§ 371 Date: Aug. 11, 2017

(30) Foreign Application Priority Data
Feb. 25, 2015 (JP) 2015-035269

(51) Int. Cl. H01M 10/0567; H01M 4/525; H01M 4/36; H01M 4/62; H01M 10/42; H01M 4/505; H01M 10/0525

(52) U.S. Cl. CPC H01M 10/0567; H01M 4/505; H01M 4/525; H01M 10/0525; H01M 4/62; H01M 10/4235; H01M 4/364; H01M 2004/028

(57) ABSTRACT

It is an object of the present invention to provide a nonaqueous electrolyte secondary battery improved not only in room-temperature output but also in low-temperature regeneration. A positive electrode plate contains a lithium transition metal oxide as a positive electrode active material. A mix of the positive electrode plate contains a tungsten oxide and a phosphate compound. A nonaqueous electrolyte contains a linear sulfonate. When both of the tungsten oxide and the phosphate compound are present near the positive electrode active material, the linear sulfonate forms a movable decomposition product by oxidative decomposition on a surface of a positive electrode without forming any coating and the decomposition product and the unreacted linear sulfonate are reductively decomposed on a surface of the negative electrode together and a low-resistance coating is thereby formed.

### TECHNICAL FIELD

The present invention relates to a nonaqueous electrolyte secondary battery.

### BACKGROUND ART

In recent years, smaller and lighter mobile data terminals such as mobile phones, notebook personal computers, and smartphones have been increasingly used and secondary batteries used as driving power supplies therefor have been required to have higher capacity. Nonaqueous electrolyte secondary batteries, which are charged and discharged in such a manner that lithium ions move between positive and negative electrodes, have high energy density and high capacity and therefore are widely used as power supplies for driving the mobile data terminals.

Furthermore, the nonaqueous electrolyte secondary batteries are recently attracting attention as motor power supplies for electric tools, electric vehicles (EVs), hybrid electric vehicles (HEVs and PHEVs), and the like and applications thereof are expected to be further expanded.

Such motor power supplies are required to have high capacity so as to be used for a long time or enhanced output characteristics in the case of repeating large-current charge and discharge in a relatively short time. It is essential that output characteristics during large-current charge/discharge are maintained and high capacity is achieved.

Patent Literature 1 describes that cycle characteristics are enhanced by using a nonaqueous electrolyte containing a sulfonate.

Patent Literature 2 describes a positive electrode active material as a material for suppressing gas generation, the positive electrode active material being prepared in such a manner that a tungstate compound and a phosphate compound are deposited on a composite oxide mainly containing lithium nickelate, followed by heat treatment.

### CITATION LIST

### Patent Literature

PTL 1: Japanese Published Unexamined Patent Application No. 2001-243982

PTL 2: Japanese Published Unexamined Patent Application No. 2010-40383

### SUMMARY OF INVENTION

### Technical Problem

However, in the above conventional techniques, low-temperature regeneration is not sufficiently investigated; hence, low-temperature regeneration is insufficient in some cases.

It is an object of the present invention to provide a nonaqueous electrolyte secondary battery improved not only in room-temperature output but also in low-temperature regeneration.

### Solution to Problem

The present invention provides a nonaqueous electrolyte secondary battery including an electrode assembly having a structure in which a positive electrode plate and a negative electrode plate are stacked with a separator therebetween and a nonaqueous electrolyte. The positive electrode plate contains a lithium transition metal oxide as a positive electrode active material. A mix of the positive electrode plate contains a tungsten oxide and a phosphate compound. The nonaqueous electrolyte contains a linear sulfonate.

As a result of intensive investigations, the inventors have found that when a linear sulfonate is present in the nonaqueous electrolyte under conditions that a tungsten oxide and a phosphate compound are present near the surface of a positive electrode active material, the linear sulfonate forms a movable decomposition product by oxidative decomposition on a surface of a positive electrode without forming any coating, the decomposition product and the unreacted linear sulfonate are reductively decomposed on a surface of a negative electrode together and a low-resistance coating is thereby formed, so that low-temperature regeneration is significantly improved without impairing room-temperature output.

Furthermore, the inventors have found that when a cyclic sulfonate is present in the nonaqueous electrolyte, a decomposition product derived from the linear sulfonate, the unreacted linear sulfonate, and the cyclic sulfonate are reductively decomposed on the negative electrode surface together and a low-resistance coating is thereby formed, so that low-temperature regeneration is further improved without impairing room-temperature output.

In an embodiment of the present invention, the tungsten oxide WO₃.

In another embodiment of the present invention, the phosphate compound is lithium phosphate.

In still another embodiment of the present invention, the number of carbon atoms in the linear sulfonate is 2 to 7.

In still another embodiment of the present invention, the linear sulfonate is any of methyl methanesulfonate, ethyl methanesulfonate, and propyl methanesulfonate.

In still another embodiment of the present invention, the number of carbon atoms in the cyclic sulfonate is 3 to 5.

In still another embodiment of the present invention, the cyclic sulfonate is 1,3-propanesultone.

In still another embodiment of the present invention, the lithium transition metal oxide contains nickel (Ni), cobalt (Co), and manganese (Mn).

In still another embodiment of the present invention, the content of the linear sulfonate is 0.1% by mass to 5% by mass with respect to the total mass of a nonaqueous solvent making up the nonaqueous electrolyte.

### Advantageous Effects of Invention

According to the present invention, a nonaqueous electrolyte secondary battery improved in low-temperature regeneration without reducing the room-temperature output.

### BRIEF DESCRIPTION OF DRAWINGS

FIG. 1 is a schematic illustration of an embodiment.

FIG. 2 is a schematic illustration of a conventional technique.

### DESCRIPTION OF EMBODIMENTS

Embodiments of the present invention are described below. Incidentally, this embodiment is an example and the present invention is not limited to the embodiments below.

A nonaqueous electrolyte secondary battery according to this embodiment has a basic configuration similar to a conventional one and includes a wound electrode assembly obtained by winding a positive electrode plate and a negative electrode plate with a separator therebetween. The outermost peripheral surface of the wound electrode assembly is covered by the separator.

The positive electrode plate includes a positive electrode core made of aluminium or an aluminium alloy. Positive electrode mix layers are formed on both surfaces of the positive electrode core such that positive electrode core-exposed portions where the core is narrowly exposed at one of lateral ends along a longitudinal direction are formed on both surfaces thereof.

The negative electrode plate includes a negative electrode core made of copper or a copper alloy. Negative electrode mix layers are formed on both surfaces of the negative electrode core such that negative electrode core-exposed portions where the core is narrowly exposed at one of lateral ends along a longitudinal direction are formed on both surfaces thereof.

The wound electrode assembly is flat and is prepared in such a manner that the positive electrode plate and the negative electrode plate are wound with the separator therebetween and are formed into a flat shape. In this operation, the positive electrode core-exposed portions are formed at one of ends of the wound electrode assembly, which is flat, so as to be wound and the negative electrode core-exposed portions are formed at the other end so as to be wound.

The wound positive electrode core-exposed portions are electrically connected to a positive electrode terminal through a positive electrode current collector. On the other hand, the wound negative electrode core-exposed portions are electrically connected to a negative electrode terminal through a negative electrode current collector. The positive electrode current collector and the positive electrode terminal are preferably made of aluminium or an aluminium alloy. The negative electrode current collector and the negative electrode terminal are preferably made of copper or a copper alloy. The positive electrode terminal is fixed to a sealing body through an insulating member. The negative electrode plate is also fixed to the sealing body through the insulating member.

The wound electrode assembly, which is flat, is housed in a prismatic enclosure in such a state that the wound electrode assembly is covered by an insulating sheet made of resin. The sealing body is brought into contact with an opening of the prismatic enclosure, which is made of metal, and a contact between the sealing body and the prismatic enclosure is laser-welded.

The sealing body has a nonaqueous electrolyte inlet. A nonaqueous electrolyte is provided from the nonaqueous electrolyte inlet. Thereafter, the nonaqueous electrolyte inlet is sealed with a blind rivet or the like. Of course, the nonaqueous electrolyte secondary battery is an example, may have another configuration, and may be, for example, a laminate-type nonaqueous electrolyte secondary battery formed by putting the nonaqueous electrolyte and the wound electrode assembly in a laminate enclosure.

Next, a positive electrode, the nonaqueous electrolyte, a negative electrode, the separator, and the like in this embodiment are described.

(Positive Electrode)

The positive electrode is composed of, for example, the positive electrode current collector, such as metal foil, and the positive electrode mix layers formed on the positive electrode current collector. The positive electrode current collector used may be foil of a metal, such as aluminium, stable in the potential range of the positive electrode; a film including a surface layer containing the metal; or the like. The positive electrode mix layers contain a lithium transition metal oxide which is a positive electrode active material, a tungsten oxide, and a phosphate compound and preferably further contain a conductive agent and a binding agent. The positive electrode can be prepared in such a manner that, for example, positive electrode mix slurry containing the positive electrode active material, the binding agent, and the like is applied to the positive electrode current collector; wet coatings are dried and are then rolled; and the positive electrode mix layers are thereby formed on both surfaces of the current collector.

When the tungsten oxide and the phosphate compound are present near the surface of the positive electrode active material and a linear sulfonate is present in the nonaqueous electrolyte, the linear sulfonate forms a movable decomposition product by oxidative decomposition on a surface of the positive electrode without forming any coating. The decomposition product and the unreacted linear sulfonate are reductively decomposed on a surface of the negative electrode together and a low-resistance coating is thereby formed, whereby low-temperature regeneration is significantly improved.

[Tungsten Oxide]

The tungsten oxide, which is contained in the positive electrode mix layers, is not particularly limited and is preferably WO₃, which is most stable and in which the oxidation number of tungsten is 6.

The content of the tungsten oxide is preferably 0.05% by mole to 10% by mole with respect to metal elements, excluding Li, in the lithium transition metal oxide; more preferably 0.1% by mole to 5% by mole; and particularly preferably 0.2% by mole to 3% by mole. When the content of the tungsten oxide is within this range, good charge/discharge characteristics are maintained and the formation of the movable decomposition product, which is derived from the linear sulfonate, on the positive electrode surface is further promoted.

The particle size of the tungsten oxide is preferably less than the particle size of the lithium transition metal oxide and is particularly preferably 25% or less of the particle size of the oxide. The particle size of the tungsten oxide is, for example, 50 nm to 10 μm. When the particle size thereof is within this range, the good dispersion of the tungsten oxide in the positive electrode mix layers is maintained and the formation of the movable decomposition product, which is derived from the linear sulfonate, on the positive electrode surface is further promoted.

Herein, the particle size of the tungsten oxide is a value that is obtained in such a manner that 100 particles of the tungsten oxide observed with a scanning electron microscope (SEM) are extracted at random and the longitudinal and lateral sizes of each particle are measured and the measurements are averaged. When the tungsten oxide is present in the form of aggregates, the particle size of the tungsten oxide is the size of the smallest unit particles forming each aggregate.

[Phosphate Compound]

The phosphate compound, which is contained in the positive electrode active material layers, is not particularly limited and is preferably lithium phosphate, lithium dihydrogen phosphate, cobalt phosphate, nickel phosphate, manganese phosphate, potassium phosphate, and/or ammonium dihydrogen phosphate. Among these, lithium phosphate is particularly preferable. Using these phosphate compounds further promotes the formation of the movable decomposition product, which is derived from the linear sulfonate, on the positive electrode surface.

The content of the phosphate compound, such as lithium phosphate, is preferably 0.03% by mass to 6% by mass with respect to the total mass of the lithium transition metal oxide (positive electrode active material), more preferably 0.06% by mass to 4.5% by mass, and particularly preferably 0.3% by mass to 3% by mass. The content of the phosphate compound is preferably 0.01% by mass to 1.5% by mass with respect to the total mass of the lithium transition metal oxide in terms of phosphorus (P) element, more preferably 0.02% .by mass to 1.2% by mass, and particularly preferably 0.1% by mass to 1% by mass. When the content of the phosphate compound is within this range, the capacity of the positive electrode is maintained, good charge/discharge characteristics are maintained, and the formation of the movable decomposition product, which is derived from the linear sulfonate, on the positive electrode surface is further promoted.

The particle size of the phosphate compound is preferably less than the particle size of the lithium transition metal oxide and is particularly preferably 25% or less of the particle size of the oxide. The particle size of the phosphate compound is, for example, 50 nm to 10 μm. When the particle size thereof is within this range, the good dispersion of the phosphate compound in the positive electrode mix layers is maintained and the formation of the movable decomposition product, which is derived from the linear sulfonate, on the positive electrode surface is further promoted. Herein, the particle size of the phosphate compound is a value that is obtained in such a manner that 100 particles of the phosphate compound observed with a scanning electron microscope (SEM) are extracted at random and the longitudinal and lateral sizes of each particle are measured and the measurements are averaged. When the phosphate compound is present in the form of aggregates, the particle size of the phosphate compound is the size of the smallest unit particles forming each aggregate.

The phosphate compound and the tungsten oxide can be attached to, for example, the surfaces of particles of the active material in such a manner that the phosphate compound and the tungsten oxide are mechanically mixed with the lithium transition metal oxide (positive electrode active material). Alternatively, the phosphate compound and the tungsten oxide may be mixed in the positive electrode mix layers in such a manner that the phosphate compound and the tungsten oxide are added in a step of preparing positive electrode mix slurry by kneading the conductive agent and the binding agent.

[Lithium Transition Metal Oxide]

The lithium transition metal oxide is preferably an oxide represented by the formula Li₁₊ₓMeₐO_{2+b} (where x+a=1, −0.2<x≦0.2, −0.1≦b≦0.1, and Me includes at least one metal element selected from the group consisting of Ni, Co, Mn, and Al). In particular, in the case of using a nickel (Ni)-containing lithium transition metal oxide, the formation of the movable decomposition product, which is derived from the linear sulfonate, on the positive electrode surface is further promoted; hence, M is preferably at least Ni. The lithium transition metal oxide preferably contains cobalt (Co) and manganese (Mn) in addition to Ni. The lithium transition metal oxide preferably contains aluminium (Al) instead of Mn in addition to Ni, Co, and Mn.

The proportion of Ni in above Me is preferably 30% by mole or more, Ni is preferably contained in the form of Ni³⁺. In the case of using a Ni³⁺-containing lithium transition metal oxide, the surface of the active material is activated and the formation of the movable decomposition product is promoted. An example of the Ni³⁺-containing lithium transition metal oxide is a lithium nickel-cobalt-manganate in which the molar ratio is Ni >Mn, that is, the molar ratio of Ni to Co to Mn is, for example, 3:5:2, 4:3:3, 5:2:3, 5:3:2, 6:2:2, 7:1:2, 7:2:1, or 8:1:1. In a lithium nickel-cobalt-aluminate, the molar ratio of Ni to Co to Al is, for example, 80:15:5, 85:12:3, or 90:7:3.

The lithium transition metal oxide preferably contains zirconium (Zr) or tungsten (W). When Zr or N is contained therein, the surface of the active material is activated and the formation of the movable decomposition product is promoted. The content of Zr or N is preferably 0.05% by mole to 10% by mole with respect to metal elements, excluding Li, in the lithium transition metal oxide; more preferably 0.1% by mole to 5% by mole; and particularly preferably 0.2% by mole to 3% by mole. When the content thereof is within this range, good charge discharge characteristics are maintained and the formation of the movable decomposition product can be promoted.

The lithium transition metal oxide may contain an additive element. Examples of the additive element include transition metal elements other than Mn, Ni, and Co; alkali metal elements; alkaline-earth metal elements; group 12 elements; group 13 elements; and group 14 elements. In particular, the following elements can be exemplified: boron (B), magnesium (Mg), titanium (Ti), chromium (Cr), iron (Fe), copper (Cu), zinc (Zn), niobium (Nb), molybdenum (Mo), tantalum (Ta), tin (Sn), sodium (Na), potassium (K), barium (Ba), strontium (Sr), calcium (Ca), and the like.

The particle size of the lithium transition metal oxide is not particularly limited and is preferably 2 λm to 30 μm. Particles of the lithium transition metal oxide are secondary particles composed of bonded primary particles with a size of, for example, 50 nm to 10 μm. The particle size of the lithium transition metal oxide is the volume-average particle size determined by laser diffractometry. The BET specific surface area of the lithium transition metal oxide is not particularly limited and is preferably 0.1 m²/g to 6 m²/g. The BET specific surface area of the lithium transition metal oxide can be measured with a known BET specific surface area analyzer.

[Conductive Agent]

The conductive agent is used to increase the electrical conductivity of the positive electrode mix layers. Examples of the conductive agent include carbon materials such as carbon black, acetylene black, Ketjenblack, and graphite. These may be used alone or in combination.

[Binding Agent]

The binding agent is used to maintain the good contact between the positive electrode active material and the conductive agent and to increase the adhesion of the positive electrode active material and the like to a surface of the positive electrode current collector. Examples of the binding agent include fluorinated resins such as polytetrafluoroethylene (PTFE) and polyvinylidene fluoride (PVdF), polyacrylonitrile (PAN), polyimide resins, acrylic resins, and polyolefin resins. These resins may be used in combination with carboxymethylcellulose (CMC), a salt thereof (that may be CMC-Na, CMC-K, CMC-NH₄, a partially neutralized salt, or the like), polyethylene oxide (PEO), and/or the like. These may be used alone or in combination.

(Nonaqueous Electrolyte)

The nonaqueous electrolyte contains a nonaqueous solvent and an electrolyte salt dissolved in the nonaqueous solvent. The nonaqueous solvent contains at least one linear sulfonate and may further contain a cyclic sulfonate. The nonaqueous solvent used may be any of esters, ethers, nitriles, amides such as dimethylformamide, and mixtures of two or more of these solvents. The nonaqueous solvent may contain a halogen-substituted compound obtained by substituting hydrogen in at least one of these solvents with an atom of a halogen such as fluorine.

The linear sulfonate, which is contained in the nonaqueous electrolyte, is not particularly limited; preferably contains two to seven carbon atoms; and is preferably methyl methanesulfonate, ethyl methanesulfonate, propyl methanesulfonate, butyl methanesulfonate, pentyl methanesulfonate, hexyl methanesulfonate, methyl ethanesulfonate, methyl propanesulfonate, methyl methanesulfonate, ethyl propanesulfonate, methyl propanesulfonate, propyl propanesulfonate, and/or the like. Among these, methyl methanesulfonate, ethyl methanesulfonate, and propyl methanesulfonate are particularly preferable. In the case of using these linear sulfonates, the effect of enhancing low-temperature regeneration characteristics is further exhibited. It is not preferable that the number of carbon atoms therein is more than 7, because the resistance increases.

The content of the linear sulfonate in the nonaqueous electrolyte is preferably 0.1% to 15% (mass ratio). This is because when the content thereof is less than 0.1%, the effect of forming a coating is not sufficiently exhibited and when the content thereof is more than 15%, the formation of a coating is excessive and the room-temperature output is low. In particular, the content thereof is more preferably 0.1% to 5%. When the content thereof is within this range, the ratio between the movable decomposition product and the undecomposed linear sulfonate is more preferable and a better coating is formed on the surface of a negative electrode active material.

The cyclic sulfonate, which is contained in the nonaqueous electrolyte, is not particularly limited and may contain two to five carbon atoms. Examples of the cyclic sulfonate include 1,3-propanesultone, 1,4-butanesultone, 2,4-butanesultone, 1,3-propenesultone, 1,4-butenesultone, 1-methyl-1,3-propanesultone, 3-methyl-1,3-propanesultone, 1-fluoro-1,3-propanesultone, and 3-fluoro-1,3-propanesultone.

Among these, 1,3-propanesultone, 1,4-butanesultone, 1,3-propenesultone, and 1,4-butenesultone are preferable and 1,3-propanesultone is particularly preferable.

The content of the cyclic sulfonate in the nonaqueous electrolyte is preferably 0.01% to 1% (mass ratio). This is because when the content thereof is less than 0.01%, the effect of forming a coating is not sufficiently exhibited and when the content thereof is more than 1%, the formation of a coating is excessive and the room-temperature output is low. In particular, the content thereof is preferably 0.1% to 0.5%. When the content thereof is within this range, the ratio between the decomposition product, which is derived from the linear sulfonate, the unreacted linear sulfonate, and the cyclic sulfonate is more preferable and a better coating is formed on the surface of the negative electrode active material.

Examples of the esters include cyclic carbonates such as ethylene carbonate (EC), propylene carbonate (PC), butylene carbonate, and vinylene carbonate (VC); linear carbonates such as dimethyl carbonate (DMC), ethyl methyl carbonate (EMC), diethyl carbonate (DEC), methyl propyl carbonate, ethyl propyl carbonate, and methyl isopropyl carbonate; and cyclic carboxylates such as γ-butyrolactone (GBL) and γ-valerolactone (GVL).

Examples of the ethers include cyclic ethers such as 1,3-dioxolane, 4-methyl-1,3-dioxolane, tetrahydrofuran, 2-methyltetrahydrofuran, propylene oxide, 1,2-butylene oxide, 1,3-dioxane, 1,4-dioxane, 1,3,5-trioxane, furan, 2-methylfuran, 1,8-cineol, and crown ethers and linear ethers such as 1,2-dimethoxyethane, diethyl ether, dipropyl ether, diisopropyl ether, dibutyl ether, dihexyl ether, ethyl vinyl ether, butyl vinyl ether, methyl phenyl ether, ethyl phenyl ether, butyl phenyl ether, pentyl phenyl ether, methoxytoluene, benzyl ethyl ether, diphenyl ether, dibenzyl ether, o-dimethoxybenzene, 1,2-diethoxyethane, 1,2-dibutoxyethane, diethylene glycol dimethyl ether, diethylene glycol diethyl ether, diethylene glycol dibutyl ether, 1,1-dimethoxymethane, 1,1-diethoxyethane, triethylene glycol dimethyl ether, and tetraethylene glycol dimethyl.

Examples of the nitriles include acetonitrile, propionitrile, butyronitrile, valeronitrile, n-heptanenitrile, succinonitrile, glutaronitrile, adiponitrile, pimelonitrile, 1,2,3-propanetricarbonitrile, and 1,3,5-pentanetricarbonitrile.

The halogen-substituted compound used is preferably a fluorinated cyclic carbonate such as fluoroethylene carbonate (FEC), a fluorinated linear carbonate, a fluorinated linear carboxylate such as methyl fluoropropionate (FMP), or the like.

The nonaqueous electrolyte used is preferably a solvent mixture of the cyclic and linear carbonates in addition to the linear sulfonate. The volume ratio of a cyclic carbonate to linear carbonate used in combination preferably ranges from 2:8 to 5:5.

The electrolyte salt is preferably a lithium salt. Examples of the lithium salt include LiBF₄; LiClO₄; LiPF₆; LiAsF₆; LiSbF₆; LiAlCl₄; LiSCN; LiCF₃SO₃; LiC(C₂F₅SO₂); LiCF₃CO₂; Li(P(C₂O₄)F₄); Li(P(C₂O₄)F₂); LiPF₆₋ₓ(CnF₂ₙ₊₁)ₓ (where 1<x<6 and n is 1 or 2); LiB₁₀Cl₁₀; LiCl; LiBr; LiI; chloroborane lithium; lithium lower aliphatic carboxylates; borates such as Li₂B₄O₇, Li(B(C₂O₄)₂) [lithium-bisoxalate borate (LiBOB)], and Li(B(C₂O₄)F₂); and imide salts such as LiN(FSO₂)₂ and LiN(C₁F₂₁₊₁SO₂)(CₘF₂₊ₘSO₂) {where l and m are integers greater than or equal to 1}. The lithium salt used may be one of these salts or a mixture of some of these salts. Among these salts, at least one fluorine-containing lithium salt is preferably used from the viewpoint of ionic conductivity, electrochemical stability, and the like. For example, LiPF₆ is preferably used. In particular, from the viewpoint that a coating stable in a high-temperature environment is formed on a surface of the negative electrode, the fluorine-containing lithium salt and a lithium salt containing oxalato complex anions (for example, LiBOB) are preferably used in combination. The concentration of the lithium salt is preferably 0.8 mol to 1.8 mol per liter of the nonaqueous solvent.

(Negative Electrode)

The negative electrode used may be a known negative electrode and is obtained in such a manner that, for example, the negative electrode active material and a binding agent are mixed in water or an appropriate solvent and the mixture is applied to the negative electrode current collector, followed by drying and rolling. The negative electrode current collector used is preferably a conductive thin film, particularly foil of a metal, such as copper, stable in the potential range of the negative electrode; alloy foil stable in the potential range thereof; a film including a metal surface layer containing copper or the like. As is the case with the positive electrode, the binding agent used may be polytetrafluoroethylene (PTFE). The binding agent used is preferably a styrene-butadiene copolymer (SBR), a modification thereof, or the like. The binding agent may be used in combination with a thickening agent such as carboxymethylcellulose (CMC).

The negative electrode active material is not particularly limited and may be one capable of reversely storing and releasing lithium ions. For example, carbon materials such as natural graphite and synthetic graphite; metals, such as Si and Sn, alloyed with lithium; alloy materials; metal composite oxides; and the like can be used. These may be used alone or in combination. In particular, a carbon material obtained by coating a graphite material with low-crystallinity carbon is preferably used because a low-resistance coating is likely to be formed on a surface of the negative electrode.

[Binding Agent]

As is the case with the positive electrode, the binding agent used may be a fluorinated resin, PAN, a polyimide resin, an acrylic resin, a polyolefin resin, or the like. In the case of preparing negative electrode mix slurry, the following agent is preferably used: styrene-butadiene rubber (SBR), CMC, a salt thereof, polyacrylic acid (PAA), a salt thereof (that may be PAA-Na, PAA-K, a partially neutralized salt, or the like), polyvinyl alcohol (PVA), or the like.

(Separator)

The separator used is a porous sheet having ionic permeability and insulation properties. Examples of the porous sheet include microporous thin films, fabrics, and nonwoven fabrics. The separator is preferably made of an olefin resin such as polyethylene or polypropylene or cellulose. The separator may be a laminate including a cellulose fiber layer and a thermoplastic resin fiber layer made of the olefin resin or the like. The separator may be a multilayer separator including a polyethylene layer and a polypropylene layer. A separator surface-coated with resin such as an aramid resin can be used.

A filler layer containing an inorganic filler may be placed between the separator and at least one of the positive electrode and the negative electrode. The inorganic filler is, for example, an oxide containing at least one of titanium, aluminium, silicon, and magnesium; a phosphate compound; or the like. The surface of the filler may be treated with a hydroxide or the like. The filler layer can be formed by applying slurry containing the filler to a surface of the positive electrode, the negative electrode, or the separator. Alternatively, the filler layer may be formed in such a manner that a sheet containing the filler is separately prepared and is attached to a surface of the positive electrode, the negative electrode, or the separator.

Next, examples are described.

### EXAMPLES

### Experiment Example 1

[Preparation of Positive Electrode Active Material]

NiSO₄, CoSO₄, and MnSO₄ were mixed in an aqueous solution and were co-precipitated, whereby a hydroxide represented by [Ni_{0.5}Co_{0.2}Mn_{0.3}](OH)₂ was synthesized. The hydroxide was fired at 500° C., whereby a nickel-cobalt-manganese composite oxide was obtained. Next, the composite oxide and lithium carbonate were mixed using a Raikai mortar. The mixing ratio (molar ratio) of the total amount of Ni, Co, and Mo to Li was 1:1.2. The mixture was fired at 900° C. for 20 hours, followed by crushing, whereby a lithium transition metal oxide (positive electrode active material) represented by Li_{1.07}Ni_{0.465}Co_{0.186}Mn_{0.279}O₂was prepared.

Next, the obtained lithium transition metal oxide was mixed with tungsten oxide (WO₃) and lithium phosphate (Li₃PO₄), the amount of tungsten oxide being 0.5% by mole of the total amount of metal elements (transition metals), excluding Li, in the oxide, the amount of lithium phosphate being 1% by mass of the mass of the oxide, whereby a positive electrode active material was obtained such that WO₃ and Li₃PO₄ were attached to the surfaces of particles of the positive electrode active material. The size of particles of WO₃ and that of Li₃PO₄ were 300 nm and 500 nm, respectively, as determined by the above method.

[Preparation of Positive Electrode]

The positive electrode active material, carbon black, and polyvinylidene fluoride (PVDF) were mixed at a mass ratio of 92:5:3. N-methyl-2-pyrrolidone (NMP) serving as a dispersion medium was added to the mixture, followed by stirring using a mixer (T.K. HIVIS MIX manufactured by PRIMIX corporation), whereby positive electrode mix slurry was prepared. Subsequently, the positive electrode mix slurry was applied to aluminium foil that was a positive electrode current collector and wet coatings were dried, followed by rolling using a rolling roller. In this way, a positive electrode including positive electrode mix layers formed on both surfaces of the aluminium foil was prepared.

[Preparation of Negative Electrode]

A graphite powder, carboxymethylcellulose (CMC), and styrene-butadiene rubber (SBR) were mixed at a mass ratio of 98:1:1, followed by adding water. This was stirred using a mixer (T.K. HIVIS MIX manufactured by PRIMIX Corporation), whereby negative electrode mix slurry was prepared. Next, the negative electrode mix slurry was applied to copper foil that was a negative electrode current collector and wet coatings were dried, followed by rolling using a rolling roller. In this way, a negative electrode including negative electrode mix layers formed on both surfaces of the copper foil was prepared.

[Preparation of Nonaqueous Electrolyte]

Ethylene carbonate (EC), ethyl methyl carbonate (EMC), and dimethyl carbonate (DMC) were mixed at a volume ratio of 30:30:40. In the solvent mixture, LiPF₆ was dissolved such that the concentration thereof was 1 mol/L. Furthermore, 0.5% by mass of vinylene carbonate and 3% by mass of ethyl methanesulfonate (EMS) were dissolved.

[Preparation of Battery]

An aluminium lead was attached to the positive electrode. A nickel lead was attached to the negative electrode. A microporous membrane made of polyethylene was used as a separator. The positive electrode and the negative electrode were spirally wound with the separator therebetween, whereby a wound electrode assembly was prepared. The electrode assembly was housed in a battery case body with a bottomed cylindrical shape, the nonaqueous electrolyte was poured thereinto, and an opening of the battery case body was then sealed with a gasket and a sealing body, whereby a cylindrical nonaqueous electrolyte secondary battery (hereinafter referred to as Battery A1) was prepared.

### Experiment Example 2

In the nonaqueous electrolyte in Experiment Example 1, 0.25% by mass of 1,3-propanesultone (PS) was further dissolved. A cylindrical battery was prepared in substantially the same manner as that used in Experiment Example 1 except the nonaqueous electrolyte. The battery prepared in this manner is hereinafter referred to as Battery A2.

### Experiment Example 3

In Experiment Example 1, 3% by mass of methyl methanelfonate (PMS) was dissolved instead of ethyl methanesulfonate (EMS). A cylindrical battery was prepared in substantially the same manner as that used in Experiment Example 1 except the nonaqueous electrolyte. The battery prepared in this manner is hereinafter referred to as Battery A3.

### Experiment Example 4

In Experiment Example 1, 3% by mass of propyl methanesulfonate (PMS) was dissolved instead of ethyl methanesulfonate (EMS). A cylindrical battery was prepared in substantially the same manner as that used in Experiment Example 1 except the nonaqueous electrolyte. The battery prepared in this manner is hereinafter referred to as Battery A4.

### Experiment Example 5

In Experiment Example 1, 1% by mass of ethyl methanesulfonate (EMS) was dissolved instead of 3%. A cylindrical battery was prepared in substantially the same manner as that used in Experiment Example 1 except the nonaqueous electrolyte. The battery prepared in this manner is hereinafter referred to as Battery A5.

### Experiment Example 6

Battery A6 was prepared in substantially the same manner as that used in Experiment Example 1 except that none of WO₃ and Li₃PO₄ was mixed with the lithium transition metal oxide prepared in Experiment Example 1 and no EMS was mixed with the nonaqueous electrolyte.

### Experiment Example 7

Battery A7 was prepared in substantially the same manner as that used in Experiment Example 1 except that no Li₃PO₄ was mixed with the lithium transition metal oxide prepared in Experiment Example 1 and no EMS was mixed with the nonaqueous electrolyte.

### Experiment Example 8

Battery A8 was prepared in substantially the same manner as that used in Experiment Example 1 except that none of WO₃ and Li₃PO₄ was mixed with the lithium transition metal oxide prepared in Experiment Example 1.

### Experiment Example 9

Battery A9 was prepared in substantially the same manner as that used in Experiment Example 1 except that no Li₃PO₄ was mixed with the lithium transition metal oxide prepared in Experiment Example 1.

### Experiment Example 10

Battery A10 was prepared in substantially the same manner as that used in Experiment Example 1 except that no EMS was mixed with the nonaqueous electrolyte prepared in Experiment Example 1.

[Comparison of Output Characteristics]

After each cylindrical battery was prepared as described above, the cylindrical battery was charged to 4.1 V with a current of 800 mA in a constant current mode under 25° C. conditions, was charged with a voltage of 4.1 V in a constant voltage mode, and was then discharged to 2.5 V with a current of 800 mA in a constant current mode. The discharge capacity determined in this way was defined as the rated capacity of the cylindrical battery.

Next, after the cylindrical batteries, Batteries A1 to A10, prepared as described above were charged to 50% of the rated capacity thereof, the regeneration value at a state of charge (SOC) of 50% was determined from the maximum current capable of performing charge for 10 seconds by the following equation when the charge cut-off voltage was 4.3 V at a battery temperature of −30° C.:

Low-temperature regeneration value (SOC of 50%)=(maximum current)×charge cut-off voltage (4.3 V).

Thereafter, after each battery was discharged to 2.5 V with 800 mA at a battery temperature of 25° C. in a constant current mode and was charged to 50% of the rated capacity thereof again, the output value at a state of charge (SOC.) of 50% was determined from the maximum current capable of performing charge for 10 seconds by the following equation when the discharge cut-off voltage was 3 V:

Room-temperature output value (SOC of 50%)=(maximum current)×discharge cut-off voltage (3 V).

The ratio between low-temperature regeneration and room-temperature output characteristics of Batteries A1 to A10 was calculated on the basis of output characteristics obtained in Experiment Example 6.

Results are shown in Table 1.

TABLE 1

| | | | | | Low- | Room- |
|---|---|---|---|---|---|---|
| | | Positive electrode | | Electrolyte | temperature | temperature |
| | Positive electrode active | mix mixture | | solution | regeneration | output |
| | material | WO₃ | Li₃PO₄ | Sulfonate content | Relative value | Relative value |
| Sample No. | Composition | (mole percent) | (mass percent) | (mass percent) | (percent) | (percent) |
| Battery A1 | Li_{1.07}Ni_{0.465}Co_{0.186}Mn_{0.279}O₂ | 0.5 | 1 | EMS: 3 | 109 | 100 |
| Battery A2 | Li_{1.07}Ni_{0.465}Co_{0.186}Mn_{0.279}O₂ | 0.5 | 1 | EMS: 3 + PS: 0.25 | 111 | 100 |
| Battery A3 | Li_{1.07}Ni_{0.465}Co_{0.186}Mn_{0.279}O₂ | 0.5 | 1 | MMS: 3 | 107 | 100 |
| Battery A4 | Li_{1.07}Ni_{0.465}Co_{0.186}Mn_{0.279}O₂ | 0.5 | 1 | PMS: 3 | 107 | 100 |
| Battery A5 | Li_{1.07}Ni_{0.465}Co_{0.186}Mn_{0.279}O₂ | 0.5 | 1 | EMS: 1 | 107 | 101 |
| Battery A6 | Li_{1.07}Ni_{0.465}Co_{0.186}Mn_{0.279}O₂ | — | — | — | 100 | 100 |
| Battery A7 | Li_{1.07}Ni_{0.465}Co_{0.186}Mn_{0.279}O₂ | 0.5 | — | — | 99 | 100 |
| Battery A8 | Li_{1.07}Ni_{0.465}Co_{0.186}Mn_{0.279}O₂ | — | — | EMS: 3 | 105 | 94 |
| Battery A9 | Li_{1.07}Ni_{0.465}Co_{0.186}Mn_{0.279}O₂ | 0.5 | — | EMS: 3 | 105 | 95 |
| Battery A10 | Li_{1.07}Ni_{0.465}Co_{0.186}Mn_{0.279}O₂ | 0.5 | 1 | — | 100 | 100 |

As is clear from the results in Table 1, Battery A1, in which the tungsten oxide and lithium phosphate are present near the surface of the lithium-nickel-cobalt-manganese composite oxide and ethyl methanesulfonate is contained in the nonaqueous electrolyte, is more excellent in low-temperature regeneration as compared to Batteries A6 to A10 and has no reduced room-temperature output.

This can be described as follows. That is, when a tungsten oxide and lithium phosphate are present near a positive electrode active material, a linear sulfonate forms a movable decomposition product by oxidative decomposition on a surface of a positive electrode without forming any coating. A low-resistance coating is formed by reductively decomposing the decomposition product and the unreacted linear sulfonate on a surface of a negative electrode together, thereby enabling low-temperature regeneration to be significantly improved (Battery A1).

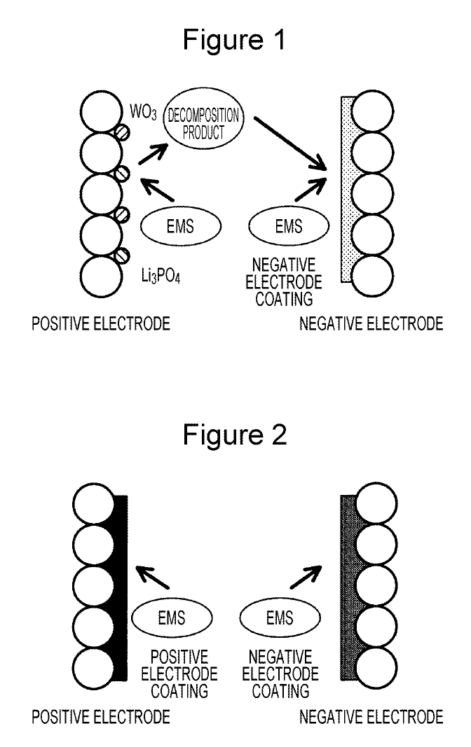

FIG. 1 is a schematic illustration of reactions on a positive electrode and a negative electrode. A linear sulfonate (EMS: ethyl methanesulfonate) forms a movable decomposition product on a surface of the positive electrode and the decomposition product and the unreacted linear sulfonate are reductively decomposed on a surface of the negative electrode, whereby a negative electrode coating with low resistance is formed.

However, when none of the tungsten oxide and lithium phosphate is present near the positive electrode active material, a high-resistance coating is formed when the linear sulfonate is decomposed on the positive electrode surface, whereby the room-temperature output is reduced. Furthermore, no movable decomposition product is formed and therefore the negative electrode coating is formed only from the linear sulfonate; hence, the degree of improvement in low-temperature regeneration is reduced (Batteries A8 and A9).

FIG. 2 is a schematic illustration of reactions on a positive electrode and negative electrode used in a conventional technique in which none of a tungsten oxide and lithium phosphate is present near a positive electrode active material. A high-resistance coating is formed on a surface of the positive electrode and a negative electrode coating is formed only from a linear sulfonate; hence, no low-resistance coating is formed.

As is clear from the results in Table 1, in the case where 0.25% by mass of 1,3-propanesultone (PS) was dissolved in a nonaqueous electrolyte, the low-temperature regeneration is more excellent and no room-temperature output is reduced (Battery A2).

This can be described as follows. That is, when a nonaqueous electrolyte is reductively decomposed on a surface of a negative electrode, a decomposition product derived from a linear sulfonate, the unreacted linear sulfonate, and a cyclic sulfonate are reductively decomposed on the negative electrode surface together, whereby a lower-resistance coating is formed and the low-temperature regeneration can be significantly improved.

As is clear from the results in Table 1, in the case where ethyl methanesulfonate in a nonaqueous electrolyte is changed to methyl methanesulfonate (MMS) or propyl methanesulfonate (PMS), a similar effect is obtained (Batteries A3 and A4).

Furthermore, as is clear from the results in Table 1, in the case where the mass percentage of ethyl methanesulfonate in a nonaqueous electrolyte is 1% by mass, the low-temperature regeneration is excellent and no room-temperature output is reduced (Battery A5).

It has been confirmed that low-temperature regeneration can be improved without reducing room-temperature output in such a manner that a lithium transition metal oxide is contained as a positive electrode active material, a tungsten oxide and a phosphate compound are contained in a positive electrode mix, and a linear sulfonate is contained in a nonaqueous electrolyte as described above.

Embodiments of the present invention have been described above. The present invention is not limited to the embodiments. Various modifications can be made within the technical spirit of the present invention.

1. A nonaqueous electrolyte secondary battery comprising an electrode assembly having a structure in which a positive electrode plate and a negative electrode plate are stacked with a separator therebetween and a nonaqueous electrolyte,
wherein the positive electrode plate contains a lithium transition metal oxide as a positive electrode active material,
a mix of the positive electrode plate contains a tungsten oxide and a phosphate compound, and
the nonaqueous electrolyte contains a linear sulfonate.

2. The nonaqueous electrolyte secondary battery according to claim 1, wherein the nonaqueous electrolyte further contains a cyclic sulfonate.

3. The nonaqueous electrolyte secondary battery according to claim 1, wherein the tungsten oxide is WO₃.

4. The nonaqueous electrolyte secondary battery according to claim 1, wherein the phosphate compound is lithium phosphate.

5. The nonaqueous electrolyte secondary battery according to claim 1, wherein the number of carbon atoms in the linear sulfonate is 2 to 7.

6. The nonaqueous electrolyte secondary battery according to claim 1, wherein the linear sulfonate is any of methyl methanesulfonate, ethyl methanesulfonate, and propyl methanesulfonate.

7. The nonaqueous electrolyte secondary battery according to claim 2, wherein the number of carbon atoms in the cyclic sulfonate is 3 to 5.

8. The nonaqueous electrolyte secondary battery according to claim 2, wherein the cyclic sulfonate is 1,3-propanesultone.

9. The nonaqueous electrolyte secondary battery according to claim 1, wherein the lithium transition metal oxide contains nickel (Ni), cobalt (Co), and manganese (Mn).

10. The nonaqueous electrolyte secondary battery according to claim 1, wherein the content of the linear sulfonate is 0.1% by mass to 5% by mass with respect to the total mass of a nonaqueous solvent making up the nonaqueous electrolyte.
